(19) United States
(12) Patent Application Publication
(10) Pub. No.: US 2003/0091819 A1
(43) Pub. Date: May 15, 2003

(54) Glue-applied resealable expanded content label

(76) Inventor: Joseph D. Franko SR., Ham Lake, MN (US)

Correspondence Address: WALTER K. ROLOFF, 490 HARBOR COURT, SHOREVIEW, MN, 55126, US

(21) Appl. No.: 10/294,111

(22) Filed: Nov. 13, 2002

Related U.S. Application Data
(60) Provisional application No. 60/338,154, filed on Nov. 13, 2001.

(51) Int. Cl. B32B 7/12; B32B 15/04

(52) U.S. Cl. 428/343; 428/352; 428/354; 428/345; 428/346

(57) ABSTRACT

A glue-applied resealable expanded content label includes a hinge portion, a release-reseal portion, a base ply having an under side and an upper side, and a top ply having an under side and an upper side. A first adhesive material is provided between the upper side of the base ply and the under side of the top ply at the hinge portion joining together the base ply and the top ply, thereby forming a hinge. A second adhesive material and a release coating are provided between the upper side of the base ply and the under side of the top ply at the release-reseal portion, wherein the release coating is substantially aligned with the second adhesive material when the label is sealed, thereby forming a release-reseal system. The second adhesive material is also provided about a perimeter of the label between the base ply and the top ply. A fugitive adhesive material may also be provided within the perimeter of the label. Such constructions alleviate warping, canoeing, blocking, and pillowing effects.

### REFERENCE TO RELATED APPLICATION

This patent application claims the benefit of a filing date of U.S. Provisional Patent Application Serial No. 60/338,154, filed Nov. 13, 2001, and entitled “GLUE-APPLIED RESEALBLE EXTENDED TEXT LABELS AND METHOD OF MANUFACTURE THEREOF”, the entire contents thereof being incorporated herein by reference thereto.

### FIELD OF THE INVENTION

The present invention relates generally to labels for product containers. The invention relates specifically to a resealable expanded content label capable of being used with conventional glue label application machines for product containers, and the like.

### BACKGROUND OF THE INVENTION

In the printing arts, and in particular in the commercial printed label art for labeling and decorating consumer products, there exists a continual demand for labels and decorations which not only appeal to consumers, but also bear ever increasing amounts of printed information. For example, labels for identification of consumer health care and pharmaceutical products are often required by governmental regulations to describe in painstaking detail their compositions and ingredients. As new food and drug laws are passed, regulations require the inclusion of increasing amounts of label information.

To provide increased printed information on labels, various forms of so-called “expanded content” labels have been proposed. As used here throughout, “expanded content labels” or “ECLs” are intended to include “extended text” labels, “booklet” type labels, and multi-layered or multiply labels, all describing labels having an appearance or effect of being comprised of multiple plies.

The expanded content type of label has gained wide popularity, wherein a base ply is joined to a top ply via an adhesive coupling or “hinge” between the two plies. Such labels normally contain two or more material plies hinged together using a pressure sensitive adhesive along one margin and a pressure sensitive release-reseal system along the opposite margin. For example, Kaufmann in U.S. Pat. No. 5,264,265; Hill et al. in U.S. Pat. No. 5,149,587; and Coward et al. in U.S. Pat. No. 5,904,973 show label constructions of this type.

Aside from the aforementioned types of expanded content labels, another label type that has been widely used for many years and is characterized in its application is the conventional and simple so-called “glue label” or “glue-applied label”. In its simplest form, a glue-applied label typically comprises a single paper ply that has printed information on one side (i.e., the upper side of the single ply). A conventional glue adhesive (such as a hot melt, or water soluble, etc.) is used on the other side (i.e., the under side of the ply) to adhere the label to a container to be labeled.

Glue-applied labels are preferred for high volume and low cost labeling applications, and have been regarded as being the least expensive to produce and apply of all container labels. Glue-applied labels have been provided with printed graphics on both the outer and back surfaces of the single ply, such as (i) those applied to clear glass bottles for viewing back surface graphics through the glass and (ii) those “tear-off” labels providing further information on the under side (e.g., recipes).

Apart from their desirable high volume/low cost attributes, glue labels produced by traditional printing methods suffer several drawbacks.

For example, a majority of traditional glue labels are manufactured by so-called “sheet fed” processes, wherein separate, autonomous converting steps are utilized as known in the art. The separate converting steps, and concomitant separate handling and re-handling of the labels during manufacture, can lead to physical damage to the labels, other losses, and undesirable results.

Also, glue labels have not heretofore provided any resealable expanded content features (such as those features of, for example, the aforementioned patents). A glue label masquerading as an expanded content label usually comprises just a simple single material ply that is folded over in a sheet fed process converting step to give an appearance and limited effect of a booklet. Unfortunately, these imposter fold-over labels are for the most part incompatible with labeling application equipment for applying glue labels to containers (variously referred to as “cut-and-stack glue labeling equipment”) because of a tendency of the fold-over labels to “pop open” to some degree while being held in a dispensing magazine stack of the glue labeling equipment.

To remedy the aforementioned drawbacks, attempts have been proposed and researched to use conventionally constructed expanded content labels (such as those of the aforementioned patents) with cut-and-stack glue labeling equipment. However, such attempted uses have generated their own problems including (i) “warping” or “canoeing” and (ii) “pillowing” effects.

The problem of warping or canoeing arises due to the fact that expanded content labels have varying thicknesses across their dimensions. That is, these labels have thicknesses at their hinge margins and at their opposite release-reseal system margins which are greater than that of an area between the two margins. Then, when the labels are held in the dispensing magazine stack of the glue labeling equipment, they tend to sag downward in that area between the margins giving a warped or canoe-shaped overall appearance in the stack. Such sagging is more pronounced as the label stack grows in height in the magazine. Magazine jamming and other problems then tend to occur in operation of the glue labeling equipment.

The problem of pillowing arises from use of the cut-and-stack glue labeling equipment itself with such conventional booklet-type labels. In this situation, the labeling equipment commonly utilizes suction-type mechanisms to manipulate labels immediately before adhesion to containers in an assembly-line process, as is well known. The suction-type mechanisms tend to pull apart the plies or cause “pillowing” of the label, since the plies are joined only at the hinge and release-reseal margins. Once again, such deformation of the labels leads to jamming and other problems in the glue labeling equipment.

Turning briefly to label manufacturing methods, it is generally accepted and well-known in the art that, for expanded content and many other labels, in-line printing and converting processes (“web presses”) offer the most cost-effective means of production of labels having “valueadded” features while assuring quality, vs. sheet fed or other “offset press” methods. An exemplary in-line web press method is disclosed in U.S. Pat. No. 4,849,043 issued to Instance, entitled “METHOD OF PRODUCING LABELS”. In particular, sheet fed or offset production of expanded content labels requires additional off-line folding and cutting operations, thereby increasing production times and costs; in some circumstances, production of a given expanded content label may be impossible.

Thus, there exists a need for a glue-applied resealable expanded content label that is relatively inexpensive to produce in an in-line web press, that may be readily used with cut-and-stack glue labeling equipment without expensive equipment modifications, and that alleviates warping and pillowing effects.

### SUMMARY OF THE INVENTION

An object of the present invention is to provide a glue-applied resealable expanded content label that is relatively inexpensive to produce in-line.

Another object of the present invention is to provide such a label that may be readily used with existing and unmodified cut-and-stack glue labeling equipment.

A further object of the present invention is to provide such a label that alleviates warping and pillowing effects in such equipment, in use.

In accordance with the present invention, a glue-applied resealable expanded content label includes a hinge portion, a release-reseal portion, a base ply having an under side and an upper side, and a top ply having an under side and an upper side. A first adhesive material is provided between the upper side of the base ply and the under side of the top ply at the hinge portion joining together the base ply and the top ply, thereby forming a hinge. A second adhesive material and a release coating are provided between the upper side of the base ply and the under side of the top ply at the release-reseal portion, wherein the release coating is substantially aligned with the second adhesive material when the label is sealed, thereby forming a release-reseal system. The second adhesive material is also provided about a perimeter of the label between the base ply and the top ply. A fugitive adhesive material may also be provided within the perimeter of the label.

### BRIEF DESCRIPTION OF THE DRAWINGS

In the drawings wherein like numerals are utilized to designate like parts throughout the same:

FIG. 1 is a front view illustration of an exemplary glue-applied resealable expanded content label in accordance with the present invention, depicted as being opened.

FIG. 2 is a cross-sectional view of the label of FIG. 1, depicted as being closed or re-sealed.

FIG. 2a is an exploded view of FIG. 2.

FIG. 3 is a top view illustration of the label of FIG. 1, shown as having been adhered to a product container.

FIG. 4 is a cross-sectional view of an alternative embodiment of the label of the present invention, depicted as being closed or re-sealed.

FIG. 5 is a cross-sectional view of another alternative of the present invention, depicted as being closed or re-sealed.

### DETAILED DESCRIPTION OF THE INVENTION

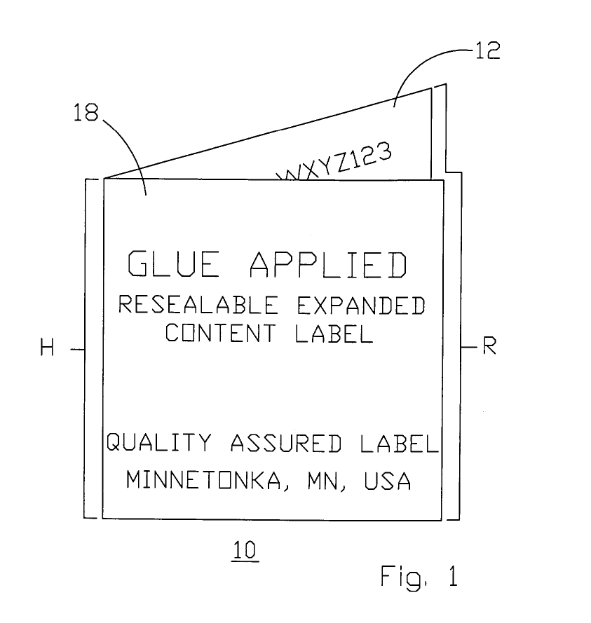

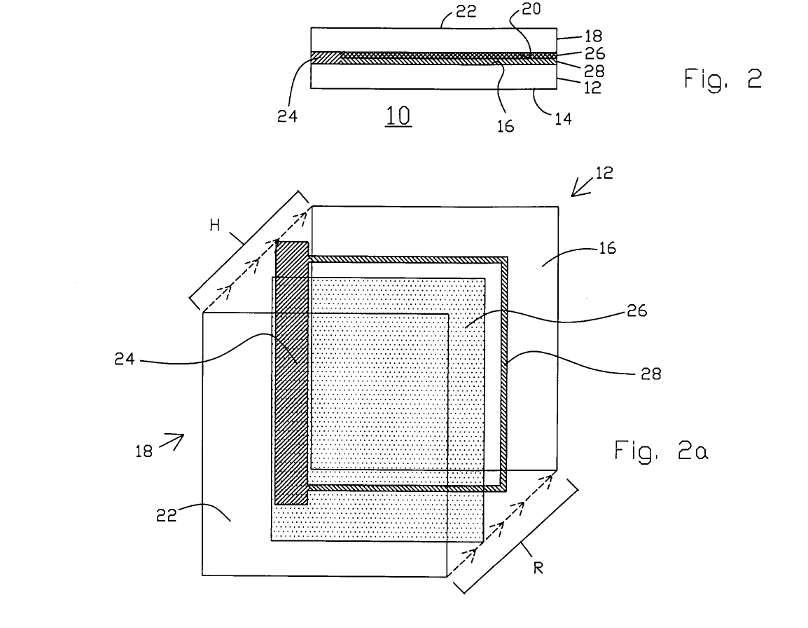

The detailed description contained herein in conjunction with the drawing figures presented is intended by way of example with respect to the inventive concept and is not intended to be limiting in any way. With this in mind, FIGS. 1-3 show an exemplary and preferred embodiment of a glue-applied resealable expanded content label 10 of the present invention. Label 10 includes a hinge portion H and a release-reseal portion R, as will be further described. Label 10 also includes a base ply 12 having an under side 14 and an upper side 16 (FIGS. 2-2a), and a top ply 18 having an under side 20 and an upper side 22.

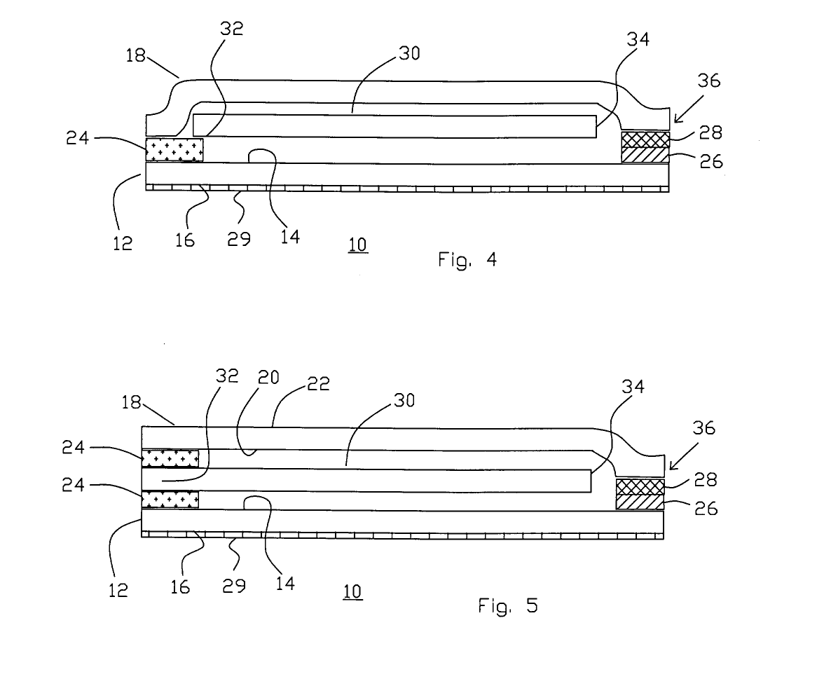

Plies 12 and 18 each are preferably web-like materials, being compatible for use in an in-line web press manufacturing method for label 10. As used herein, “web-like materials” denotes any suitable material or combination hereof, including but not limited to paper, film, polypropylene, polyethylene, polyester, polyvinylchloride, polystyrene, foil, and ethylene vinyl acetate, whether clear, opaque, or metallized. These web-like materials for plies 12 and 18 (and ply 30, as will be described relative to FIGS. 4-5) may be made of any suitable materials that meet physical and chemical compatibility requirements, along with desired aesthetic attributes and cost considerations of a particular label. As shown in FIG. 1, the plies are capable of receiving printed graphic text and images thereon, during, for example, manufacture of labels 10 in an in-line web press (not illustrated). It is to be understood that where necessary, the sides or surfaces of the plies to be printed may receive one or more depositions of material to “adjust” receptiveness to printing materials. Thus, an array of papers, plastics, and related materials may variously be employed for the plies, the surfaces of which may be adjusted as needed by those skilled in the art. As best seen in FIGS. 2-2a, top ply 18 is joined to base ply 12 along a strip that is normally hinge portion H using a first adhesive material 24 that is preferably “permanent” to form a binding or hinge between side 16 of ply 12 and side 20 of ply 18. First adhesive material 24 as a permanent adhesive is designed to cause permanent adhesion of top ply 18 to base ply 12. In this manner, top ply 18 resists unintentional peeling away and removal from label 10, as is apt to occur with pressure sensitive adhesives which are often used in the hinged construction of expanded content labels, even though such bonds may occasionally be referred to as “permanent”.

It is to be noted particularly that a consumer may, inadvertently, attempt to peel back or open an expanded content label at an incorrect location. The preferred permanent adhesive hinge of the present invention will inhibit an inadvertent splitting apart of the plies of label 10 at its hinge portion H.

With continued reference to FIGS. 1 and 2a, relative to release-reseal portion R, a portion of upper side 16 of base ply 12 is provided with a release coating 26 which may cover almost entirely an area of upper side 16 exclusive of regions corresponding to first adhesive material 24 in “zone coat” fashion as shown in FIG. 2a, or some lesser amount. Release coating 26 is typically a varnish, lacquer, ink, or other coating that acts to inhibit permanent adhesions. A second adhesive material 28 that is preferably of the so-called pressure sensitive type is provided about a perimeter of label 10 as shown in FIG. 2a. This material 28, in conjunction and being substantially aligned with release coating 26 as shown in the figures, enables release and resealing of top ply 18. In combination, second adhesive material 28 and release coating 26 may be characterized as a “release-reseal system”. Adhesive materials 24 and 28 may be in forms of continuous, discontinuous, or intermittent patterns. In this regard, it is only necessary (i) that adhesive material 24 (and the hinge in general) provides sufficient strength to securely bond plies 12 and 18 together, (ii) that adhesive material 28 (and the release-reseal system in general) provides sufficient tack to prevent unaided or unintentional opening of label 10, and (iii) that the pattern of adhesive material 28 be substantially aligned with release coating 26 when plies 12 and 18 are sealed.

One skilled in the art will recognize from the foregoing that two distinct types of adhesive materials are employed in label 10, namely, “permanent” adhesive materials and “pressure-sensitive” adhesive materials. It is to be particularly appreciated that, as used herein, a “permanent” adhesive is one that is tack-free in its cured or final adhesive state, in bonding plies together.

The class known as “permanent” adhesives may be further characterized as including (i) any glues, (ii) non-pressure sensitive adhesive materials including but not limited to heat seal adhesives, (iii) multiple part epoxies, (iv) chemical welding or bonding, and (v) mechanical fastening means, that all achieve a desired result of securely bonding two plies together. In this regard, a universally accepted reference text, The Concise Encyclopedia of Polymer Science and Engineering (New York, 1990) states at page 35, with respect to permanent adhesive bonds: “Eventually, the adhesive must undergo a phase change, i.e., by cooling, solvent evaporation or reaction, to a solid in order for the [bonded] joint to acquire the necessary strength to resist shearing forces.”

Permanent adhesive materials used in hinge portion H of label 10, for example, are preferably selected from adhesives including hot melt adhesives, solvent-based adhesives, water-based adhesives, and UV(ultraviolet)-curable and EB(electron beam)-curable adhesives. Examples of preferred permanent adhesive materials include UV-curable adhesives such as those available from RAD-CURE Corporation of Fairfield, N.J., including RAD-CURE 10PSLVA,B.

The class of adhesives known as “pressure-sensitive” adhesives is contrasted with permanent adhesives in the next sentence of the aforecited reference text that reads: “A notable exception is the category of pressure-sensitive adhesives, where no phase change occurs.” This also describes the term “pressure sensitive” as used herein. Such pressure sensitive materials remain tacky. Adhesion may be modified (reduced) by providing deadening or detackifying overlayers, but the material does not solidify. Generally, bonds between plies made using pressure-sensitive adhesives can be pulled apart without damage to the plies, whereas those made using permanent adhesives cannot. This is particularly true with respect to multiple-ply expanded content labels. It is also to be noted that label plies of an exclusively pressure-sensitive label construction are easily yield to moving and shifting forces due to the relative softness of the pressure-sensitive adhesive material.

Within a class, preference of one such adhesive over another will particularly depend upon a drying or curing system of a given web press, along with materials composition and compatibility considerations.

It is also to be noted that although depicted in one configuration in the figures, the materials and coatings of label 10 may be applied to corresponding plies in any order, either separately, as one on each ply, or together as a combination on one ply. Thus, for example, preferred permanent adhesive material 24 may be applied to upper side 16 of base ply 12 and/or to under side 20 of top ply 18. Preferred pressure sensitive second adhesive material 28 may also be applied to upper side 16 of base ply 12 or to under side 20 of top ply 18, while release coating 26 may be applied, respectively, to under side 20 of top ply 18 or to upper side 16 of base ply 12. Second adhesive material 28 may also be applied in any varying intermittent patterns about all or only a portion of the aforementioned perimeter of label 10 if desired.

As a further refinement to the preferred exemplary embodiment of the present invention, an amount of a so-called “fugitive” adhesive material (not illustrated) may be provided within the perimeter of label 10 (e.g., within an area bounded by adhesive 28) on either ply 12 or 18. The fugitive adhesive is preferably non-permanent, and serves to adhesively join plies 12 and 18 in interior portions thereof only slightly. It is to be appreciated by those skilled in the label making arts, then, that this fugitive adhesive alleviates the afordescribed pillowing effect which is encountered with use of glue labeling equipment. Preferably, also, the fugitive adhesive is chosen such that upon application of the label to a container and subsequent initial opening thereof by a consumer, the fugitive adhesive ceases to adhere the plies together in any appreciable way. Suitable fugitive adhesives are commercially available from, for example, RAD-CURE Corporation of Fairfield, N.J.

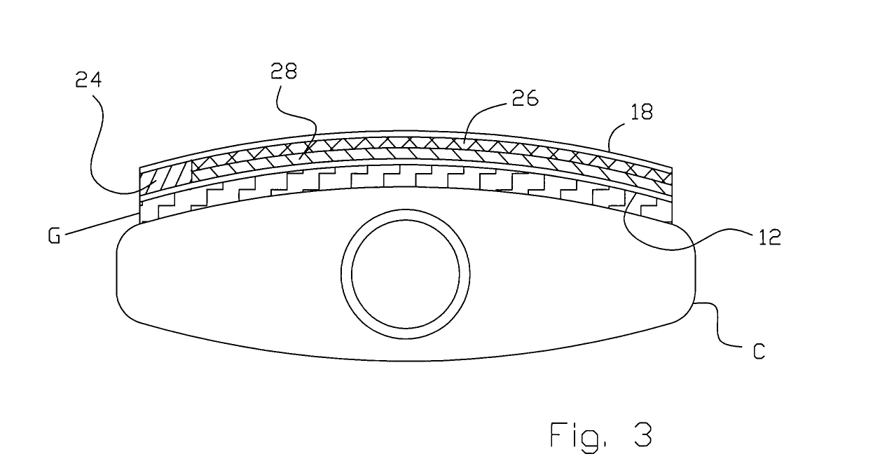

As shown in FIG. 3, label 10 may be readily adhered by a conventional wet glue G, by way of conventional glue labeling equipment (not shown), to virtually any container C to be labeled, including those containers that have traditionally been labeled by conventional, single ply glue labels.

Turning, now, to FIGS. 4 and 5, alternate constructions of the label of the present invention are depicted. Therein, at least one middle or intermediate ply 30 having an under side and an upper side is provided between base ply 12 and top ply 18. In FIG. 4, intermediate ply 30 is also hinged by first adhesive material 24 along one edge at 32, and has free sides and a free end 34. Thus, label 10 of FIG. 4 may be characterized as having a “shared hinge”. In FIG. 5, this arrangement is modified somewhat, in that a separate deposition of first adhesive material 24 is substituted for the shared hinge of FIG. 4. Thus, in FIG. 5, intermediate ply 30 is hinged to base ply 12, and top ply 18 is consecutively hinged to intermediate ply 30, in layered fashion.

In either case, end 34 of intermediate ply 30 terminates before reaching second adhesive material 28 of the release-reseal system so that it is captured within label 10 when top ply 18 is held closed by the release-reseal system.

As can be seen in FIGS. 4 and 5, the release-reseal system may be preferably limited to a vicinity of a second edge as at 36 which is opposite the hinge margin or hinge edge or strip 32. Of course, the release-reseal system requires only that release coating 26 be substantially aligned with adhesive material 28 on an opposing surface of the adjacent ply. It is to be understood that, although not shown to preserve clarity of the drawings, adhesive material 28 is preferably provided about the perimeter of label 10 in a manner as that described relative to FIG. 2a.

Regardless of a given embodiment of label 10 discussed above, it is to be particularly appreciated that adhesive material 28 provided about the perimeter of label 10 is set back to some degree from edges of plies 12 and 18, to inhibit any occurrence of “adhesive ooze” that may be experienced when adhesive material 28 is a pressure sensitive adhesive. In this regard also, it is to be appreciated that if a pressure sensitive adhesive was substituted for the preferred permanent first adhesive material 24, then a higher likelihood of “adhesive ooze” and many problems attendant therewith (i.e., “blocking”) in dispensing, application, and use of label 10 would be expected.

It is to be further appreciated that the aforedescribed features of (i) the perimeter adhesive, and (ii) the fugitive internal adhesive, either alone or in combination, give the expanded content label of the present invention all the desired dispensing and container application attributes of traditional single-ply glue labels by way of elimination of warping, canoeing, blocking, and pillowing effects.

It is to be noted that the labels of the present invention may be created entirely in-line, in a roll-to-roll process, thereby assuring quality and low cost. Such in-line processes include any suitable multi-unit in-line presses such as narrow- or wide-web platform presses, whether flexographic, letterpress, gravure, screen, or offset. Such presses are commercially available from, for example, Comco International of Milford, Ohio, and Mark Andy Inc. of St. Louis, Mo.

Although a permanent adhesive has been disclosed herein as being preferred for adhesive material 24, a pressure sensitive adhesive could, of course, be readily substituted therefor.

Furthermore, it is to be understood that various materials may be substituted in construction of the labels of the present invention. In the preferred and exemplary embodiment herein, a paper base ply 12 and film top ply 18 was disclosed. A film top ply is preferred for its flexibility relative to curved or irregular container surfaces to be labeled, while a paper base ply is well suited for adhesion to a container by way of a wet glue. However, paper could of course be substituted for film, and vice-versa, depending upon label cost parameters and other particular desires of a label customer. In the case of a film base ply, it is known to those skilled in the art that conventional wet glues used in glue labeling equipment do not adhere well thereto. In response to this problem, Krones AG of Neutraubling, Germany and Applied Extrusion Technologies, Inc. (AET Films) of Terre Haute, Ind., USA, have developed a technique for glue labeling equipment utilizing a liquid adhesive (analogous to a wet glue) that is UV- or EB-cured or activated just prior to application thereby rendering a satisfactory pressure-sensitive type adhesive for attachment of the film to a non-porous container.

It will also be appreciated that as used here throughout and in the drawings, the terms “printing”, “graphics” and “coatings” include, but are not limited to, various printing media, adhesives, hot melts, varnishes, inks, release coatings, etc.

The invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

For example, it will be appreciated that any of the aforedescribed graphics, coatings, materials, and release-reseal systems may be selectively provided in any suitable combination on labels constructed according to the present invention, for a particular desired use. Thus, in FIGS. 2, 4, and 5, the relative positions of release coating 26 and second adhesive material 28 could be interchanged.

It is also to be understood in general that any suitable alternatives may be employed to provide the glue-applied resealable expanded content label of the present invention.

Lastly, the choice, of course, of compositions, sizes, and strengths of various aforementioned components of the label of the present invention are all a matter of design choice depending upon intended uses thereof.

1. A glue-applied resealable expanded content label, comprising:
(a) a hinge portion and a release-reseal portion;
(b) a base ply having an under side and an upper side;
(c) a top ply having an under side and an upper side;
(d) a first adhesive material provided between said upper side of said base ply and said under side of said top ply at said hinge portion joining together said upper side of said base ply and said under side of said top ply, thereby forming a hinge; and
(e) a second adhesive material and a release coating provided between said upper side of said base ply and said under side of said top ply at said release-reseal portion, wherein said release coating is substantially aligned with said second adhesive material when said label is sealed, thereby forming a release-reseal system, and wherein said second adhesive material is provided about a perimeter of said label between said base ply and said top ply.

2. The label as in claim 1, wherein said first adhesive material and said second adhesive material are selected from a group of adhesives consisting of hot melt adhesives, solvent-based adhesives, water-based adhesives, and UV-curable and EB-curable adhesives.

3. The label as in claim 1, wherein said first adhesive material and said second adhesive material may be provided as a discontinuous pattern.

4. The label as in claim 1, wherein said release coating of said release-reseal system is provided on said upper side of said base ply.

5. The label as in claim 1, wherein said release coating of said release-reseal system is provided on said under side of said top ply.

6. The label as in claim 1, wherein said release coating further extends beyond said second adhesive material.

7. The label as in claim 1, further comprising at least one intermediate ply having an under side and an upper side provided between said base ply and said top ply, wherein said under side of said intermediate ply is joined to said upper side of said base ply at said hinge portion, such that said hinge is shared by said intermediate ply and said top ply.

8. The label as in claim 1 wherein said intermediate ply is hinged to said base ply, and said top ply is consecutively hinged to said intermediate ply, in layered fashion.

9. A glue-applied resealable expanded content label, comprising:
(a) a hinge portion and a release-reseal portion;
(b) a base ply having an under side and an upper side;
(c) a top ply having an under side and an upper side;
(d) a first adhesive material provided between said upper side of said base ply and said under side of said top ply at said hinge portion joining together said upper side of said base ply and said under side of said top ply, thereby forming a hinge;
(e) a second adhesive material and a release coating provided between said upper side of said base ply and said under side of said top ply at said release-reseal portion, wherein said release coating is substantially aligned with said second adhesive material when said label is sealed, thereby forming a release-reseal system; and
(f) a fugitive adhesive material provided within a perimeter of said label between said base ply and said top ply.

10. The label as in claim 9, wherein said first adhesive material and said second adhesive material are selected from a group of adhesives consisting of hot melt adhesives, solvent-based adhesives, water-based adhesives, and UV-curable and EB-curable adhesives.

11. The label as in claim 9, wherein said first adhesive material and said second adhesive material may be provided as a discontinuous pattern.

12. The label as in claim 9, wherein said release coating of said release-reseal system is provided on said upper side of said base ply.

13. The label as in claim 9, wherein said release coating of said release-reseal system is provided on said under side of said top ply.

14. The label as in claim 9, wherein said release coating further extends beyond said second adhesive material.

15. The label as in claim 9, further comprising at least one intermediate ply having an under side and an upper side provided between said base ply and said top ply, wherein said under side of said intermediate ply is joined to said upper side of said base ply at said hinge portion, such that said hinge is shared by said intermediate ply and said top ply.

16. The label as in claim 9 wherein said intermediate ply is hinged to said base ply, and said top ply is consecutively hinged to said intermediate ply, in layered fashion.
